(19) United States
(12) Patent Application Publication
(10) Pub. No.: US 2004/0207940 A1
(43) Pub. Date: Oct. 21, 2004

(54) Interior rearview mirror with magnesium components

(76) Inventors: John W. Carter, Holland, MI (US); Wayne Rumsey, Zeeland, MI (US); Kenton J. Ypma, Hudsonville, MI (US); Daniel J. Bostwick, Grandville, MI (US); Jeremy A. Fogg, Holland, MI (US)

Correspondence Address: PRICE, HENEVELD, COOPER, DEWITT, & LITTON,, LLP/GENTEX CORPORATION, 695 KENMOOR, S.E., P O BOX 2567, GRAND RAPIDS, MI, 49501, US

(21) Appl. No.: 10/812,110

(22) Filed: Mar. 29, 2004

Related U.S. Application Data
(63) Continuation-in-part of application No. 10/405,526, filed on Apr. 2, 2003.

(51) Int. Cl. G02B 7/182

(52) U.S. Cl. 359/879; 359/871

(57) ABSTRACT

An interior rearview mirror assembly comprising a plate frame, a mirror adjacent a front of the plate frame, a pivot ball connected to the plate frame for pivoting the plate frame, and a mount connected to the pivot ball and configured to be connected to a windshield of a vehicle. At least one of the plate frame, the pivot ball and the mount are made of a material comprising a magnesium alloy.

### CROSS-REFERENCE TO RELATED APPLICATION

The present application is a continuation-in-part of U.S. application Ser. No. 10/405,526 filed on Apr. 2, 2003, entitled REARVIEW MIRROR WITH INTEGRATED FRAME, now U.S. Pat. No.______, the entire contents of which are hereby incorporated herein by reference.

### BACKGROUND

The present invention concerns vehicle mirrors, and more particularly relates to rearview mirrors having an integrated frame.

Interior and exterior rearview mirrors of modern passenger vehicles have become heavier as more content and features are added. For example, many modern vehicle mirrors include several of the following options: electrochromic mirror subassemblies and circuitry to reduce glare, keyless entry sensing systems, microphone-speaker-antennae-phone communication systems, audio-control systems, compass and temperature devices and displays, lighting, switches for control of electrical circuits, and the like. Since most vehicle mirrors are supported from one side (usually a back or topside), this added weight creates a pendulum effect that causes the mirrors to shake, vibrate, and resonate unacceptably. In order to reduce the shaking, vibration, and resonation, the rear support area on most rearview mirrors is beefed up to increase rigidity and stability, and/or reinforcement ribs are added to the rear support area. However, any increase in wall thickness and/or increase in the number of reinforcement ribs adds to part weight, adds to sinks and blemishes and other quality problems when molding the parts, and adds to part complexity. Further, the added ribs take up substantial space, making a profile of the mirrors much larger. It is desirable to provide a mirror design where the number of reinforcement ribs and webs in a mirror housing is minimized or eliminated, and where the mirror housing is primarily designed as a cosmetic covering rather than a structural member. It is noted that vehicle manufacturers have high visual standards for the housings of interior rearview mirrors, since vehicle passengers not only look at and touch the mirror housings often, but also the mirrors are in a position where every blemish and defect is easily seen.

Modern interior rearview mirrors are typically mounted from their hidden backside by an elongated mount, and are made to be angularly adjustable by a ball-and-socket connector that connects the mirror to the mount. This allows each vehicle driver to angularly adjust the mirror to an optimal position and preference. The adjustable connector is made sufficiently rigid to hold the mirror in a selected angular position, even when receiving substantial vibrational stress. However, the adjustable connectors include multiple separate parts and pieces that require assembly, and further take up space. It would be desirable to provide a mount where the ball and socket connection was better integrated into one of the mirror components.

Still another concern is wire management. Modern vehicle mirrors can have several wires connected to internal components within the mirror head. These wires need to be managed so that they do not become entangled or pinched during assembly or during angular adjustment. Further, mis-positioning of wires can cause substantial variation in electromagnetic interference and radio frequency interference emitted from power-using electrical components on the mirror, which is of increasing concern to vehicle manufacturers. It is desirable to provide a mirror having an integrated wire management system so that wires are well managed and consistently located in the mirror, and so that the wires are integrally shielded along with the electrical devices that they are connected to.

Another concern is impact testing and vehicle safety. For example, at least one vehicle manufacturer requires that the mirror glass not break or result in separation of large glass pieces from the mirror, particularly where the glass pieces are more than 2.5 mm from a crack line, since loose broken glass can be injurious to a vehicle driver or passenger. Hence, it is important that glass elements be supported in a manner that minimizes a tendency of the glass to be sharply bent and broken upon impact, and that holds the glass elements in a manner keeping broken pieces from coming loose upon impact. This problem can be complicated in an electrochromic (EC) mirror since an EC mirror has two glass elements with an EC material therebetween.

In addition to the above problems, as mirrors have become increasingly complex and sophisticated, the number of parts and pieces necessary for assembly has increased. It is desirable to provide an improvement where the many parts and pieces can be assembled in a more open physical arrangement, rather than having to be assembled into the cavity of a concave mirror housing. It is also potentially preferable that the mirror housing be designed more for “pure aesthetics,” such that functional aspects are not as much of a concern.

Accordingly, an apparatus is desired having the aforementioned advantages and solving and/or making improvements on the aforementioned disadvantages.

### SUMMARY OF THE PRESENT INVENTION

An aspect of the present invention is to provide a method of making an interior rearview mirror assembly comprising providing interior rearview mirror components, with the components comprising a plate frame, a cover, a mount and a pivot ball. The method also includes providing a mirror and assembling the interior rearview mirror components and the mirror to form the interior rearview mirror assembly. Providing the interior rearview mirror components includes thixo-forming at least one of the components from a material comprising a magnesium alloy.

Another aspect of the present invention is to provide a method of making an interior rearview mirror assembly comprising providing interior rearview mirror components, with the components comprising a plate frame and a cover. The method also includes providing a mirror and assembling the interior rearview mirror components and the mirror to form the interior rearview mirror assembly. Providing the interior rearview mirror components includes forming at least one of the components from a material comprising a magnesium alloy.

Yet another aspect of the present invention is to provide an interior rearview mirror assembly comprising a plate frame made of a material comprising a magnesium alloy, an electrochromic mirror adjacent a front of the plate frame, a circuit board adjacent a rear of the base frame, a pivot ball connected to the plate frame for pivoting the electrochromic mirror and a mount connected to the pivot ball and configured to be connected to a windshield of a vehicle.

A further aspect of the present invention is to provide an interior rearview mirror assembly comprising a plate frame, a stem extending from the plate frame and a pivot ball located on an end of the stem opposite the plate frame. The plate frame, the stem and the pivot ball are integrally formed from a material comprising a magnesium alloy.

Another aspect of the present invention is to provide an interior rearview mirror assembly comprising a plate frame, an electrochromic mirror adjacent a front of the plate frame, a circuit board adjacent a rear of the base frame, and a cover surrounding the plate frame and the electrochromic mirror. At least one of the plate frame and the cover is formed from a material comprising a magnesium alloy.

Yet another aspect of the present invention is to provide an interior rearview mirror assembly comprising a plate frame, an electrochromic mirror adjacent a front of the plate frame, a circuit board adjacent a rear of the base frame, a pivot ball connected to the plate frame for pivoting the electrochromic mirror, and a mount connected to the pivot ball and configured to be connected to a windshield of a vehicle. At least one of the plate frame, the pivot ball and the mount are made of a material comprising a magnesium alloy.

These and other aspects, objects, and features of the present invention will be understood and appreciated by those skilled in the art upon studying the following specification, claims, and appended drawings.

### BRIEF DESCRIPTION OF DRAWINGS

FIGS. 1-2 are front and top views of a mirror assembly embodying the present invention.

FIG. 2A is similar to FIG. 2 but showing a thinner mirror assembly.

FIGS. 3-4 are cross-sectional views taken along the lines III-III and IV-IV in FIG. 1.

FIG. 5 is an enlargement of the circled area V in FIG. 3.

FIG. 6 is an exploded perspective view of the mirror in FIGS. 1-4.

FIG. 7 is a fragmentary cross-sectional view taken horizontally through a center of a first modified mirror assembly.

FIG. 8 is a cross-sectional view taken along the line VIII-VIII in FIG. 7.

FIG. 9 is a fragmentary cross-sectional view similar to FIG. 7 but of a second modified mirror assembly.

FIG. 10 is a vertical cross-sectional view taken vertically through a third modified mirror assembly, including a button and switch operably positioned on the plate frame.

FIGS. 11-13 are a fragmentary side view, a cross section, and a fragmentary side view of alternative plate frames, where the plate frames include a tube, a ball and a socket to form a ball-and-socket connection, FIG. 12 being a cross section taken along line XII-XII in FIG. 11.

FIGS. 14-15 are top and front views of a mirror embodying the present invention.

FIGS. 16-18 are cross sections, FIGS. 16 and 18 being taken along the lines XVI-XVI and XVIII-XVIII in FIG. 14, FIG. 17 being similar to FIG. 16 but with the back cover and bezel removed for clarity.

FIG. 19 is an enlargement of the circled area XIX in FIG. 18.

FIGS. 20-21 are top and front views of a mirror embodying the present invention.

FIGS. 22-23 are cross sections taken along the lines XXII-XXII and XXIII-XXIII in FIG. 21.

FIGS. 24-25 are top and front views of another mirror embodying the present invention.

FIGS. 26-29 are cross sections, FIGS. 26 and 28 being taken along the lines XXVI-XXVI and XXVIII-XXVIII in FIG. 25, and FIGS. 27 and 29 being similar to FIGS. 26 and 28 but with the back cover and bezel removed for clarity.

FIGS. 30-32 are front, cross section, and exploded perspective views of additional mirrors embodying aspects of the present invention.

FIG. 33 is a perspective view of a pivot ball formed from a material comprising a magnesium alloy according to the present invention.

FIGS. 34A-34D are perspective views of mounts formed from a material comprising a magnesium alloy according to the present invention.

### DETAILED DESCRIPTION OF PREFERRED EMBODIMENTS

Reference will now be made in detail to the present preferred embodiments of the invention, examples of which are illustrated in the accompanying drawings. Wherever possible, the same reference numerals will be used throughout the drawings to refer to the same or like parts.

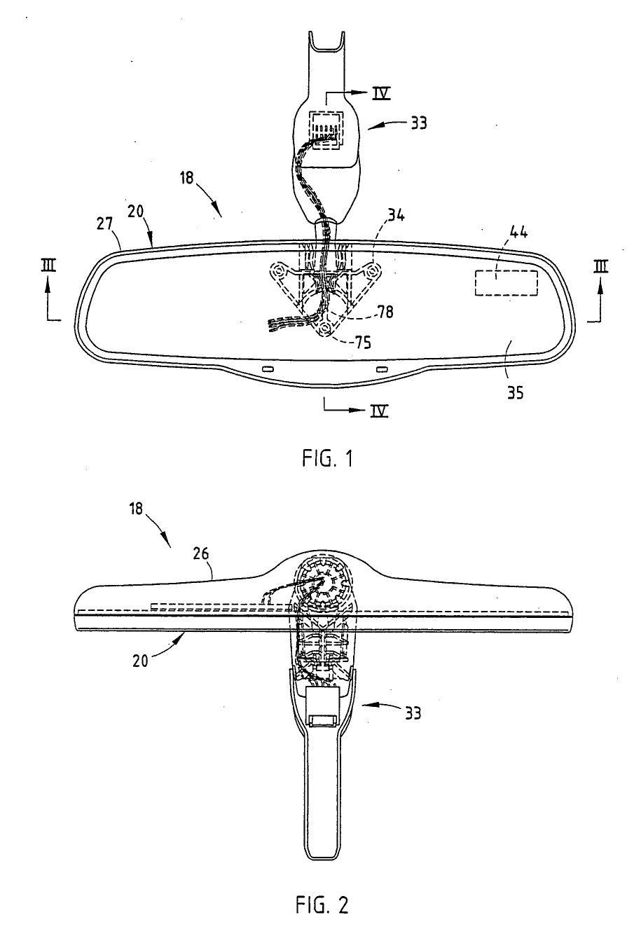

For purposes of description herein, the terms “upper,” “lower,” “right,” “left,” “rear,” “front,” “vertical,” “horizontal,” “top,” “bottom,” and derivatives thereof shall relate to the invention as viewed in FIG. 1. However, it is to be understood that the invention may assume various alternative orientations, except where expressly specified to the contrary. It is also to be understood that the specific device illustrated in the attached drawings and described in the following specification is simply an exemplary embodiment of the inventive concepts defined in the appended claims. Hence, specific dimensions, proportions, and other physical characteristics relating to the embodiment disclosed herein are not to be considered as limiting, unless the claims expressly state otherwise.

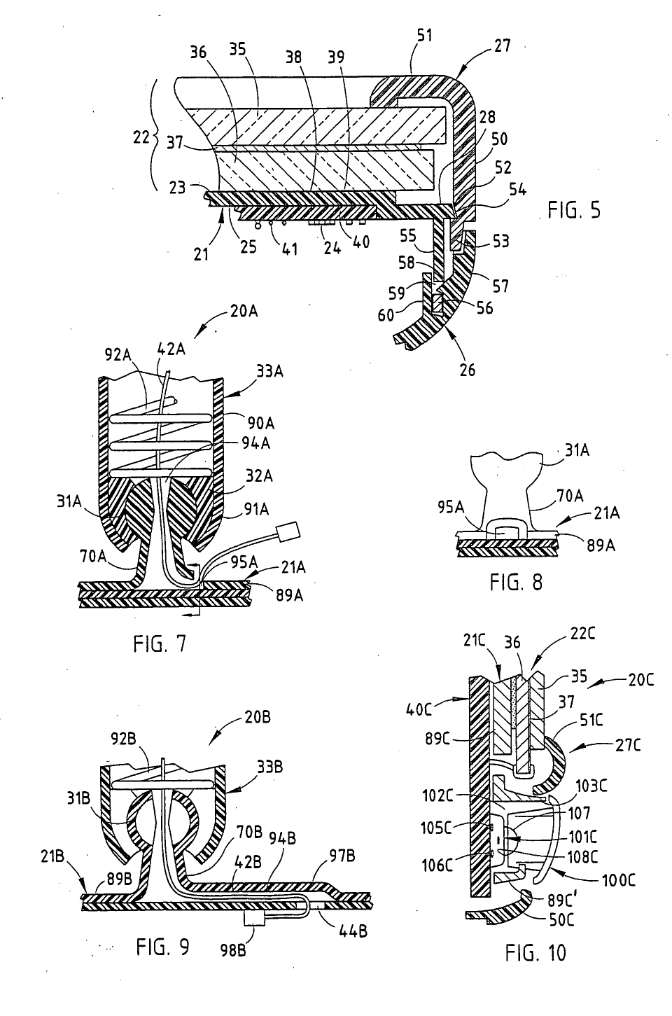

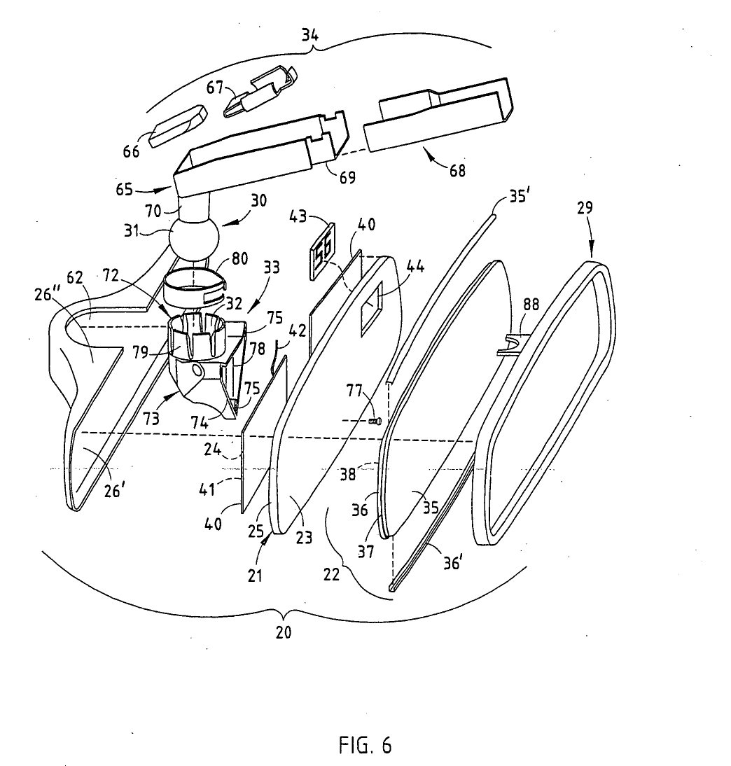

An apparatus 18 includes a mount 33 supporting an EC mirror 20 for angular adjustment (FIGS. 1-4) on the front windshield 19 of a vehicle. The electrochromic mirror 20 (FIG. 6) includes an internal plate frame 21 (FIGS. 5-6) with an electrochromic (EC) mirror subassembly 22 supported on a front surface 23 of the plate frame 21. Electrical components 24 are supported by a circuit board 40 attached to a rear surface 25 (or to the front surface 23) of the plate frame 21 with the plate frame 21 acting as a heat sink and as an EMI and/or RFI shield, as discussed below. A back cover 26 and bezel 27 are supported on a perimeter edge 28 of the plate frame 21 and cover the rear surface 25, the edge 28, and an outer edge of the EC mirror subassembly 22. In the illustrated embodiment of mirror 20, the EC mirror subassembly 22 is uniformly and continuously supported across the front surface 23 of the plate frame 21 (except at relatively small locations such as display-receiving aperture 44) for good mirror impact resistance in a vehicle crash. The mirror 20 is supported by an angularly adjustable ball-and-socket connection 30 (FIG. 6) formed by a ball section 31 on a glass-attached mount 33, and a mating socket 32 in an attachment component 34 attached directly to the plate frame 21.

In the illustrated mirror 20 (FIG. 6), the socket 32 is formed by an attachment component 34 attached directly to the plate frame 21, and the ball section 31 is formed on a mount 33. Due to the improvements associated with the plate frame 21 (and also plate frame 21A, 21B and 21C described below), including its high strength and wide reach while maintaining a minimal thickness, the present mirror 20 (and mirrors 20A-20C) is surprisingly thin, with at least 50% of the depth dimension D1 (FIG. 3) being less than about 3 cm, and at least 50% of the depth dimensions being less than 15% of the maximum width dimension W1. More preferably, at least about 50% of the depth dimensions are less than about 3.0 cm, and also are less than about 12% of a maximum width dimension. Further, it is estimated that a weight of the mirror head can be reduced by 10%-20% (see FIG. 5, the mirror head including the attachment component 34 but not including the ball section 31) and can be reduced by as much as 30%-40% (see FIGS. 7-10, the mirror head including a metal plate with an integrally formed ball section with wireway hole therethrough, but not including the mount with socket-forming bushings and coil spring). The present arrangement takes maximum advantage of the high strength internal frame 21 and the lightweight cover 26 (as opposed to a much heavier plastic rear housing with stiffening ribs around the pivotal-adjusting connection area) and further reduces a tendency of the mirror 20 to vibrate since there is a lower pendulum effect. Specifically, the mirror 20 has a center of gravity closer to the ball-and-socket connection, due to the thinner total mirror thickness, and has a reduced pendulum effect due to its lighter weight.

It is noted that the integrated plate frame 21 can be made from a variety of different metals and also potentially can be made from some composite materials that are capable of maintaining a very flat front surface for supporting the glass. Thermal expansion is important to maintaining flatness under the widely varying temperatures often seen in vehicle passenger compartments. In particular, plate frame materials having a thermal expansion close to the thermal expansion of glass have less of a tendency to create bowing and localized surface distortions, since there are less stresses developed due to dissimilar thermal expansions. For example, it has been found that steel will work well for plate frame 21, since glass has a thermal expansion of about 4.5×10⁻⁶ in/in/° F. (8.0 mm/mm/° K.), while steel has a thermal expansion of about 6.5×10⁻⁶ in/in/° F. (11.5.0 mm/mm/° K.). Alternatively, magnesium has a thermal expansion of about 13.8×10⁻⁶ in/in/° F. (24.5 mm/mm/° K.), while aluminum has a thermal expansion of about 13.0×10⁻⁶ in/in/° F. (23.9 mm/mm/° K.), and ABS/PC plastic has a thermal expansion of about 40×10^{31 6} in/in/° F. (71 mm/mm/° K.). Nonetheless, it is noted that each of these materials can be used in combination with the present inventive concepts to produce a mirror having beneficial aspects where the plate frame design is modified to accommodate the dissimilar thermal expansion.

A brief discussion follows that is sufficient to provide an understanding of the present invention to persons skilled in this art. Nonetheless, it is noted that electrochromic mirror subassemblies, such as EC subassembly 22, are generally well known in the art. Thus, a detailed description is not necessary to provide an understanding of the present invention to a person skilled in this art. Further, though a particular EC mirror subassembly is shown, it is specifically contemplated that the present inventive concepts will work on many such EC mirror subassemblies.

Briefly, the illustrated EC subassembly 22 (FIG. 5) includes front and rear glass elements 35 and 36, with a layer of electrochromic (EC) material 37 between. Top and bottom electrical conductors 35′ and 36′ (FIG. 6) are connected to opposing sides of the EC material 37 and are operably connected to a control circuit 41 on a circuit board 40, described below.

The reflective layer 38 is located either on the front surface of the second glass element 35 (called a third surface reflector) or on the rear surface of the second glass element 36 (called a fourth surface reflector). In the present arrangement, there is a double-sided tape 39 adhering a rear of the EC mirror subassembly 22 to the front surface 23 of plate frame 21. It is contemplated that other attachment means could be used instead of adhesive tape, such as a layer of adhesive. Alternatively, mechanical edge connectors (such as tabs or resilient fingers) near edges of the plate frame 21 could be used to retain the EC subassembly 22 to the plate frame 21 in a multi-layer arrangement permitting some lateral slippage of the EC subassembly 22 on the plate frame 21. It is contemplated that the EC subassembly 22 could also be retained to the plate frame 21 by the bezel 27. Alternatively, it is conceived that the reflective layer 38 can be formed directly on a front surface of the internal plate frame 21 as a third surface reflector, and the second glass element 36 eliminated.

The illustrated plate frame 21 is preferably made from a stiff strong material (such as steel or magnesium) having a high strength-to-weight ratio is dimensionally very stable, and further has properties allowing it to be made with a very uniform and consistently flat surface. The magnesium material has a thermal expansion rate of about 13.8×10⁻⁶ in/in/° F. (24.5 mm/mm/° K.), which based on testing is similar enough to the thermal expansion of glass to provide a stable arrangement satisfactory for many automotive applications. However, it is noted that other metals, such as steel, have thermal expansion properties closer to glass. In particular, steel has a thermal expansion of about 6.5×10⁻⁶ in/in/° F. (11.5.0 mm/mm/° K.), which is relatively close to the thermal expansion of about 4.5×10⁻⁶ in/in/° F. (8.0 mm/mm/° K.) for glass.

Where the thermal expansion of such materials is not as well matched to glass, care must be used in attaching the EC subassembly 21 to the plate frame to minimize stress during assembly and to avoid unacceptable distortions and non-uniform stress in the glass elements 35 and 36, since such distortions can result in buckling or cracking of the glass and/or distortion of reflected images. The fluidity and tackiness of the adhesive tape 39 can also be important in reducing or distributing stress, including stress from thermal expansion or contraction. Also, the thickness of the glass elements is important in preventing distortion of reflected images. For example, by using magnesium or steel, it has been found that a thickness of the rear glass element 36 can be reduced from the more normal glass thickness of about 2.2⁺ mm, to a reduced glass thickness as low as about 1.6 mm, and potentially even as low as 1.1 mm, and the front glass element 35 can be reduced in thickness to about 1.6 mm or even lower, depending upon functional considerations of the mirror design. When aluminum is used, it is conceived that the thickness of plate frame 21 itself can be reduced to a surprisingly thin dimension, such as about 1.0 to 1.5 mm thick. When die-cast grade magnesium is used, it is conceived that the thickness of plate frame 21 can be reduced even more, such as to about 1.0 mm or less. Also, apertures can be cut into the plate frame to further reduce weight, with the apertures having a size sufficiently small enough to allow the glass elements of the mirror subassembly to span the apertures without distortion.

The electrical components 24 (FIG. 6) are mounted on a circuit board(s) 40 and are interconnected to each other to form an electrical circuit 41 operably connected to the EC material 37 for darkening the EC material 37 to reduce a reflection of glaring headlights of vehicles following the vehicle of mirror assembly 20. The electrical control circuit 41 includes wires 42 that connect to a vehicle wiring harness that extends from the mount 33 up and along the vehicle roof and down the vehicle's “A” pillar to the vehicle's electrical system.

The plate frame 21 (FIG. 6) (also called an internal, integrated frame) is made of metal such as magnesium, which is particularly strong and dimensionally accurate. The plate frame 21 is sufficiently strong to be the primary support for mirror 20. The EC mirror subassembly 22 is attached to a front surface of the plate frame by a double-sided adhesive tape 39 (FIG. 5). A compass and temperature display 43 can be added, which fits into an aperture/pocket 44 in a face of the plate frame 21. The illustrated pocket 44 extends completely through the plate frame 21, but it is contemplated that it could instead be a recess that extends only partially into the plate frame 21. Circuit boards 40 include edges or tabs that are frictionally attached or that are heat staked onto the rear surface of the plate frame 21, and carry components such as diodes, lights, displays, switches, and other components 24. Alternatively, components such as diodes, lights, LEDs, displays, displays, switches, and the like can also be mounted directly on the plate frame 21, either on the front or rear surfaces 23 and 25, or in recesses or apertures in the front or rear of the plate frame 21. Advantageously, the plate frame 21 is thermally conductive, and acts as a very good heat sink for power-using components of the EC control circuit 41 and for heat generating components such as diodes, light sources, LED and the like. Also, the plate frame 21 is an excellent shield against electromagnetic interference (EMI) and radio frequency interference (RFI). Thus, the plate frame 21 acts as an excellent shield where wire management channels and apertures are provided and the wires are well managed tightly against a rear surface of the mirror subassembly, or where tabs are formed to partially encase component. (See FIGS. 7-10.)

Since the plate frame 21 is the main structural member that carries a load of the mirror 20, the cover 26 is merely an aesthetic enclosure hung on the plate frame 21. Accordingly, the cover 26 no longer requires the ribs and thickness required of traditional mirror housings, especially around the mounting area near the ball-and-socket connection 30. Instead, the cover 26 can thus be nothing more than a cover. This has great advantages, since the cover 26 can be made thinner, lighter, and from less expensive plastic. Further, molding of the cover 26 is simplified and quality improved over prior housings, since the stiffening ribs and webs around the socket area are eliminated. (In prior art, the stiffening ribs and webs were a quality problem, since they tend to cause molding problems including sinks and visible marks on an outside of the housing. Further, the ribs and webs made the mold tooling much more expensive and difficult to maintain.)

Bezel 27 (FIG. 5) extends around a perimeter of the EC mirror subassembly 22, and has a J-shaped cross section. The J-shaped cross section includes a straight side section 50 spaced from an edge of the glass elements 35 and 36, and a front arching section 51 with an end that curls around and engages the front surface of the front glass element 35 slightly inboard of an edge of the glass element 35. The side section 50 includes a configured trailing end with a notch 52 shaped to engage a tip 54 of the plate frame 21, and a tapered end 53.

The outer perimeter edge of the plate frame 21 includes the tip 54 that engages notch 52, and further includes a rearward-extending perimeter lip 55 forming a recess on a rear side of the plate frame 21 for receiving the circuit board 40. Bosses 55′ and/or stand-offs and/or tabs are located on a rear of the plate frame 21 for attachment of items to the plate frame 21. For example, the bosses 55′ receive screws to securely attach the attachment component 34 to the plate frame 21. The plate frame 21 still further includes a rearward extending attachment flange 56. The cover 26 includes an outboard flange 57 that overlaps the tapered end 53 of the bezel 27. The illustrated outboard flange 57 of the cover 26 is spaced from and does not engage or press on the bezel side section 50 (and notch 52). Instead, there is a gap formed therebetween so that there is no risk of squeaking or rattling. However, it is contemplated that the overlap could be constructed so that the outboard flange 57 presses on the bezel side section 50 to maintain engagement of the tip 54 of the plate frame 21 with the notch 52. The outboard flange 57 on the cover 26 includes an inwardly extending protrusion 58 that engages an aperture 59 on the attachment flange 56 of the plate frame 21. A second attachment flange 60 on the cover 26, which lies parallel and inboard of the flange 56, engages an inside surface of the attachment flange 56 and helps keep the protrusion 58 in secure attachment with the aperture 59.

The cover 26 includes a relatively thin rear wall 26′ of uniform thickness, with minimal reinforcement ribs and webs, since they are not needed for structure. A perimeter wall 26″ (FIG. 6) extends forwardly from the rear wall 26′ to define a concave shape. A top portion of the perimeter wall 26″ includes a forwardly open slot 62 for receiving the ball-and-socket connection 30.

There are a variety of different mounts that can be used to hold the present mirror 20, including single and double ball-and-socket mounts. The illustrated mount 33 (FIG. 6) includes an injection-molded or die-cast base 65 adapted for connection to a window-adhered bracket 66 via a clip 67 on the base 65. The clip 67 engages opposing sides of the bracket 66. A tunnel cover 68 telescopingly attaches to a top flange 69 of the base 65 for covering wires 42 extending from the mirror 20 up through attachment component 34 and base 65 to a location above a vehicle headliner. The base 65 includes reinforcement ribs and webs to secure a down stem 70, which stem 70 supports the ball section 31. A wireway is formed through the ball section 31 and stem 70 for routing wires from the mirror 20 (or, alternatively, the wires can be routed parallel and above the stem 70 in a semi-hidden position).

The attachment component 34 (FIG. 6) includes a crown section 72 and an attachment section 73. The attachment section 73 includes a triangularly-shaped flat side 74 shaped for stably engaging a rear surface of the plate frame 21. Three apertured bosses 75 on the attachment section 73 align with three apertured bosses 76 in the plate frame 21, for receiving screws 77 to secure the plate frame 21 to the attachment section 73. The attachment section 73 is generally hollow to facilitate molding, but includes one or more reinforcement ribs 78 that stiffen and strengthen the attachment section 73. The illustrated member 34 includes a wireway passage that extends laterally through the attachment component 34 and upwardly through a center of the crown section 72. The crown section 72 includes a plurality of resilient protrusions 79 that extend upwardly, and that have outer surfaces forming a cylinder for receiving a hoop clamp 80, and that have inner surfaces forming a socket 32 for receiving the ball section 31. As the ball section 31 is extended downwardly into the socket 32, the protrusions 79 flex outward and then return to their inward positions. Thereafter, the clamp 80 is applied, holding the protrusions 79 snugly against the ball section 31 for adequate static friction to hold a selected position, but with sufficient controlled force to permit angular adjustment. It is noted that the ball section 31 and stem 70 could be designed to extend rearwardly, instead of downwardly.

It is noted that the bezel 27 (FIG. 6) includes a rearwardly extending tab 82 that closes a front portion of the slot 62 in a top of the cover 26.

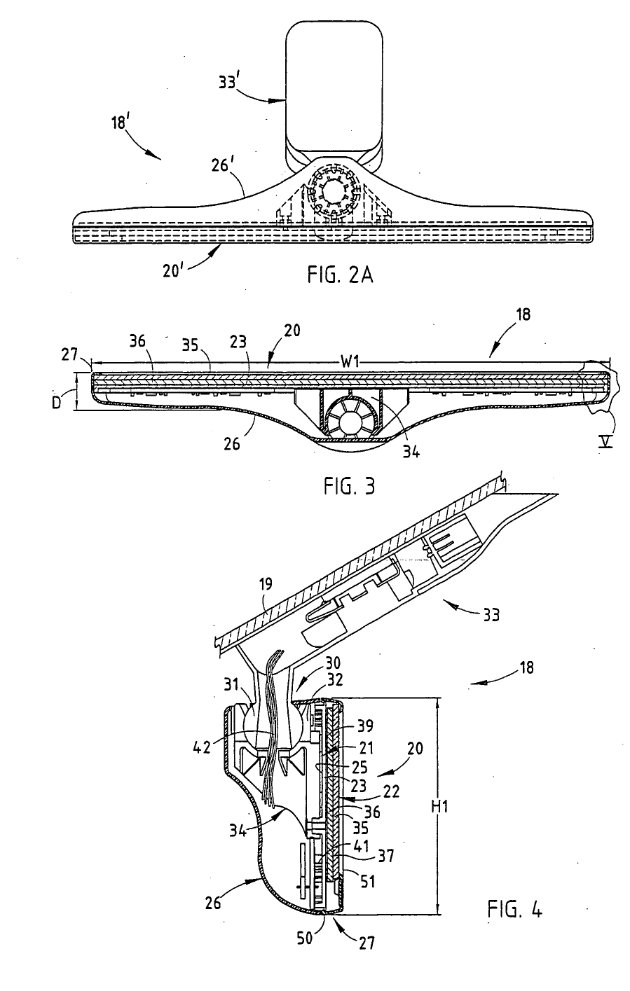

Mirror 20′ (FIG. 2A) is similar to mirror 20 (FIG. 2), except that mirror subassembly 20′ including back cover 26′ are 30% thinner in depth. (The front profile of the mirror subassembly 20′ and its internal components are basically the same as mirror 20.) Also, the mount 33′ of the apparatus 18′ has a different shape.

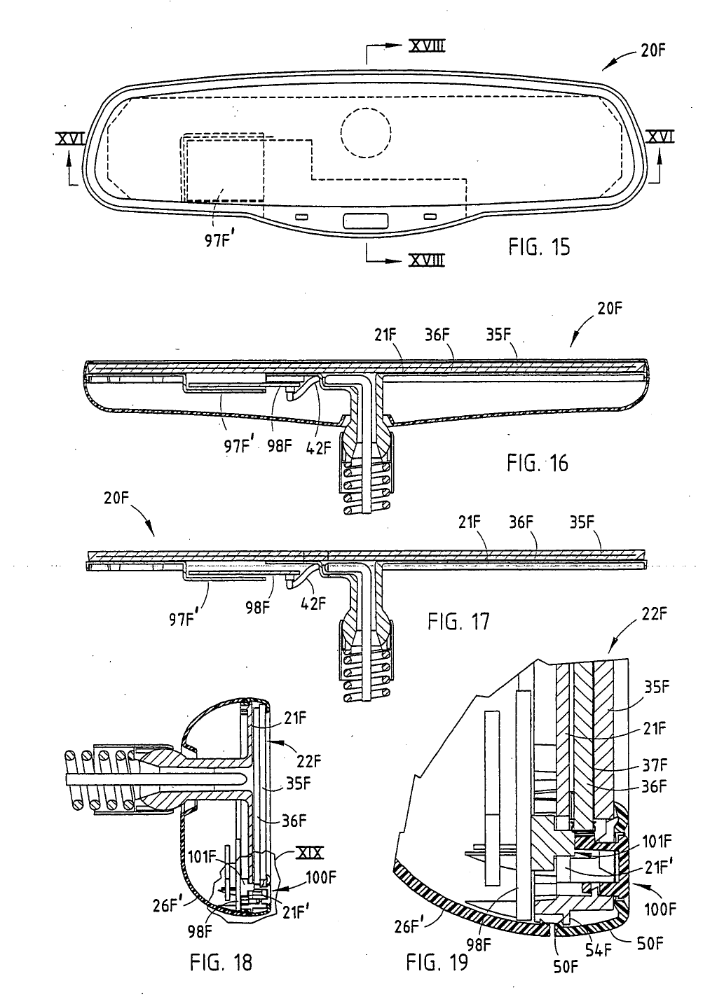

The mirrors shown in FIGS. 7-29 are similar to but are modified from the mirror 20. Features and characteristics on the mirrors that are identical or similar to mirror 20 are identified using identical numbers along with the letters “A”, “B”, etc., respectively, to reduce redundant discussion.

In the illustrated mirror 20, the socket 32 is formed by an attachment component 34 that is attached directly to the plate frame 21, and the socket 32 is formed on a mount 33. In a second embodiment of FIGS. 7-8, the plate frame 21A of a mirror 20A includes a ball section 31A and stem 70A formed integrally from the material of the plate frame 21A (FIGS. 7-9). The ball section 31A and stem 70A extend rearward from the plate frame 21. It is noted that several different materials may be used to form the plate frame 21A with integral ball section 31A and stem 70A, such as magnesium, aluminum, and deep draw steels . . . and even potentially a strong, stiff plastic or composite.

The mirror 20A (FIGS. 7-8) includes a plate frame 21A attached to a mount 33A. The illustrated plate frame 21A is a die-cast magnesium part, with an integrally formed stem 70A and ball section 3 1A integrally cast onto a back side of the plate portion 89A of the plate frame 21A. The mount 33A includes a tube 90A with a formed end 91A holding socket-forming bearings 32A against the ball section 31A. A coil spring 92A biases the bearings 32A against the end 91A. It is contemplated that mount 33A can be a one-ball mount, with the ball-and-socket connection 30A being only at a single end, or can be a two-ball mount, with a ball-and-socket connection at each end. The illustrated stem 70A and ball section 31A have a wireway/passageway 94A formed therethrough for passing wires 42A from the mirror 20A to the mount 33A. A lateral opening 95A is formed at a root of the stem 70A, slightly above the plate portion 89A of the plate frame 21A. The opening permits wires 42A to be passed out a side of the stem 70A to locations optimally suited for attachment to electrical components 24 and circuit 41. It is contemplated that the passageway 94A can be a hole requiring feed-through of wires 42A, or can be an open channel with an overhanging side flange permitting lay-in of wires 42A (with the overhanging flange both helping to contain the wires and also shield any EMI or RFI emissions).

Mirror 20B (FIG. 9) includes a plate frame 21B made from a sheet of a deep-draw steel. The stem 70B and ball section 31B are formed from the material of the plate portion 89B of the plate frame 21B. A shielding tunnel or channel 97B is formed on a face of the plate portion 89B for managing wires 42B as the wires 42B pass from the passageway 94B along the channel 97B and through the aperture 44B. The channel 97B can be formed under the second mirror element (36), with the mirror element (36) bridging over the channel 97B. Alternatively, the channel 97B can be formed in a chin area of the mirror 21B, below the EC mirror subassembly 22B, where the electrical connector or device 98B does not interfere with the glass elements of the EC mirror subassembly (22). For example, the device 98B could be a button on the “chin” area of a mirror assembly 20B. Alternatively, a channel (not unlike channel 97B) can be formed on a side of the plate portion 89B for communicating wires 42B along a side of the plate portion 89B. Notably, the channel 97B is large enough to carry the wires 42B without a tight fit, but the access opening to the channel 97B is sufficiently small such that the elements (36) of the EC mirror subassembly 21B can span the access opening without distortion as they bridge the access opening.

Mirror 20C (FIG. 10) includes a plate frame 21C and a circuit board 40C, with buttons 100C and switches 101C operably mounted directly onto and into the plate frame 21C and the circuit board 40C. FIG. 10 is a vertical cross section taken through a lower central “chin” area on the mirror 20C. The vertical cross section passes through the button 100C and shows each of the plate frame 21C, the circuit board 40C, the bezel 27C, the button 100C, and the components of the switch 101C. The lower portion 89C′ of the plate portion 89C of the plate frame 21C includes an aperture 102C for receiving the button 100C, and further includes a forward rib 103C. The rib 103C includes a tip that forms a top pivot/guide for the button 100C and further includes a bottom tip that forms a stop that engages the button 100C for limiting the maximum depth of movement of the button 100C when the button 100C is depressed. The rib 103C also promotes a better and more consistent gap and appearance around the button 100C. Alternatively, it is contemplated that the rib 103C and lower portion 89C′ can be components separate from the plate frame 21C. In such case, they would be attached to and supported on the circuit board 40C or attached to and supported on the bezel 27C.

Two electrical contacts 105C and 106C are positioned on the circuit board 40C and connected to the electrical control circuit 41C on the circuit board 40C. A patch of resilient film 107C is positioned over the electrical contacts 105C and 106C, and an electrically conductive member 108C is attached under the patch 107C in a position where it will electrically connect the contacts 105C and 106C when the switch 101C is made. The button 100C is positioned over the patch of film 107C. When the button 100C is depressed, the button 100C depresses film 107C and moves the conductive member 108C into operative contact with the contacts 105C and 106C, completing the circuit for operating whatever electrical device is connected to the electrical contacts 105C and 106C. When the button 100C is released, the resilient patch of film 107C biasingly moves the button 100C back to an at-rest position, where the conductive member 107C disconnects from the contacts 105C and 106C and breaks the circuit.

Though mirrors 20-20C are flat mirrors, it is contemplated that the present arrangement could be used in non-flat mirrors and aspheric mirrors. Such mirrors are often used in Europe. Such mirrors have glass elements that are bent or dished. Thus, reflected images seen in the mirror are reduced in size, but a larger viewing area is visible.

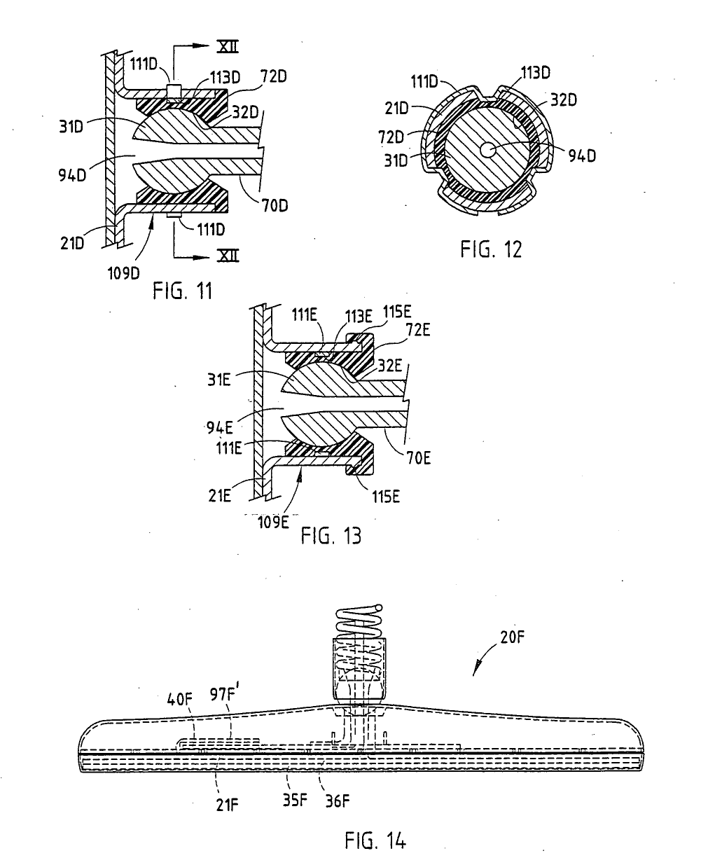

In the embodiment of FIG. 11, a mirror 20D includes an internal plate frame 21D having a tubular section 109D integrally formed thereon that extends rearwardly. The tubular section 109D includes longitudinally extending grooves 110D, three such grooves being illustrated. A crown-shaped bearing 72D defines a socket 32D for receiving a ball section 31D. An annular spring 111D extends around the tube section 109D and includes inwardly extending sections 112D (FIG. 12) that extend into the grooves 110D in the tube section and into grooves 113D in the crown bearing 72D, to retain the crown bearing 72D in place. Thus, the ball section 31D engages the socket 32D in the crown bearing 72D to form an angularly adjustable ball and socket connection. A hole 94D extends through the stem 70D and through the ball section 31D to allow wire passage.

In the mirror arrangement 20E (FIG. 13), the plate frame 21E includes a tube section 109E similar to tube section 109D (FIG. 11). However, an end of the tube section 109E includes an annular ridge or a plurality of protrusions or detents 115E that extends outwardly. The crown 72E includes an inner portion 116E that forms the socket 32E. A spring 111E wraps around the crown and biases the inner sections 116E inwardly against the ball section 31E. An annular trailing flange 117E on the crown 72E extends from the inner portion 116E around the end of the tube section 109E. The annular reversed flange 117E includes a recess that mateably snap-lockingly engages the detent 115E to retain the crown bearing 72E in position. The stem sections 70E extend from the ball section 31E and integrally connect to a mount for attachment to a vehicle windshield.

Mirror 20F (FIGS. 14-19) discloses a complete mirror having a construction similar to mirror 20A and 20B. In particular, we note the plate frame 21F that incorporates an elongated tunnel 97F forming a shield for wires 42F. Notably, the shield 97F further includes an enlarged tab 97F′ that partially shields a circuit board 98F. Also, the button 100F (FIG. 19) includes a switch 101F mounted on a circuit board 98F and that is operable by button 100F under the mirror subassembly 22F and through a hole 21F′ in the integrated plate frame 21F. A bezel 50F extends around the arrangement and includes a lip 50F that snappingly engages an end 54F of the plate frame 21F to retain the bezel in position. The back cover 26F also includes a front edge 26F′ that engages the edge of the plate frame 21F to retain the back cover in position, such as by a similar snap-attach connection.

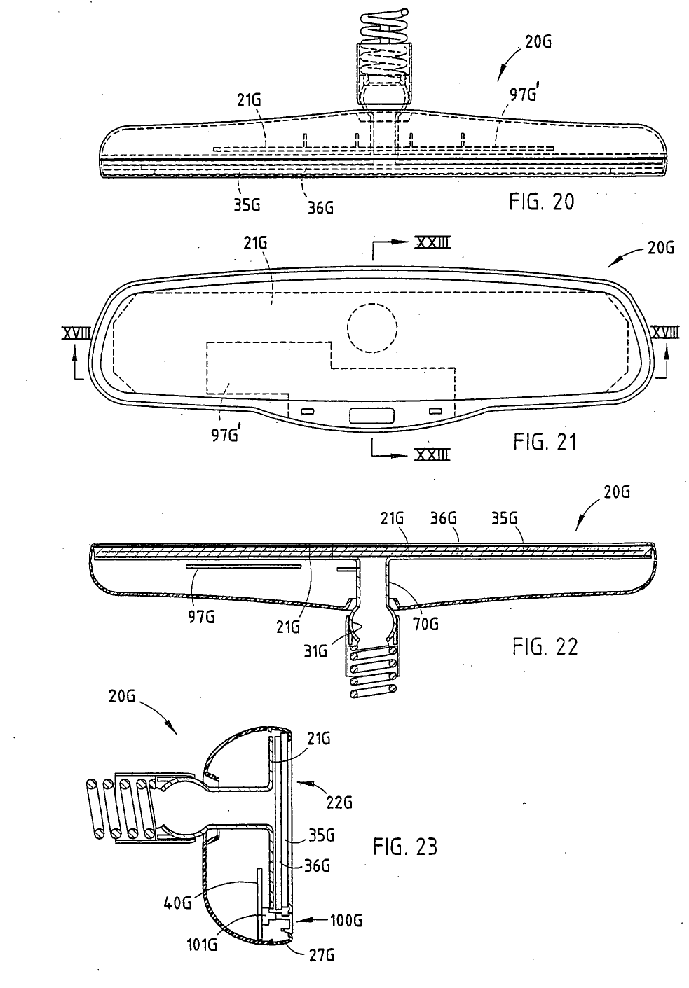

Mirror 20G (FIGS. 20-23) includes a mirror arrangement similar to the integrally formed ball section and stem of the plate frame 21A of mirror 20A (FIG. 7), however, the ball section 31G and stem 70G are formed from a deep-draw material that is flowed and formed into the tube section 70G and ball section 31G to have a constant thin wall. Also, the tunnel shield 97G (FIG. 22) is formed on a backside of the plate frame 21G and further an aperture or hole 95G is formed in a base or root of the stem 70G for egress and entrance of wiring. Still further, a button arrangement 100G (FIG. 23) is formed along a lower central edge of the mirror in a chin area similar to mirror 20G (FIG. 23). The illustrated button 100G is operably supported on the bezel 27G, and the switch 101G is supported on the circuit board 40G.

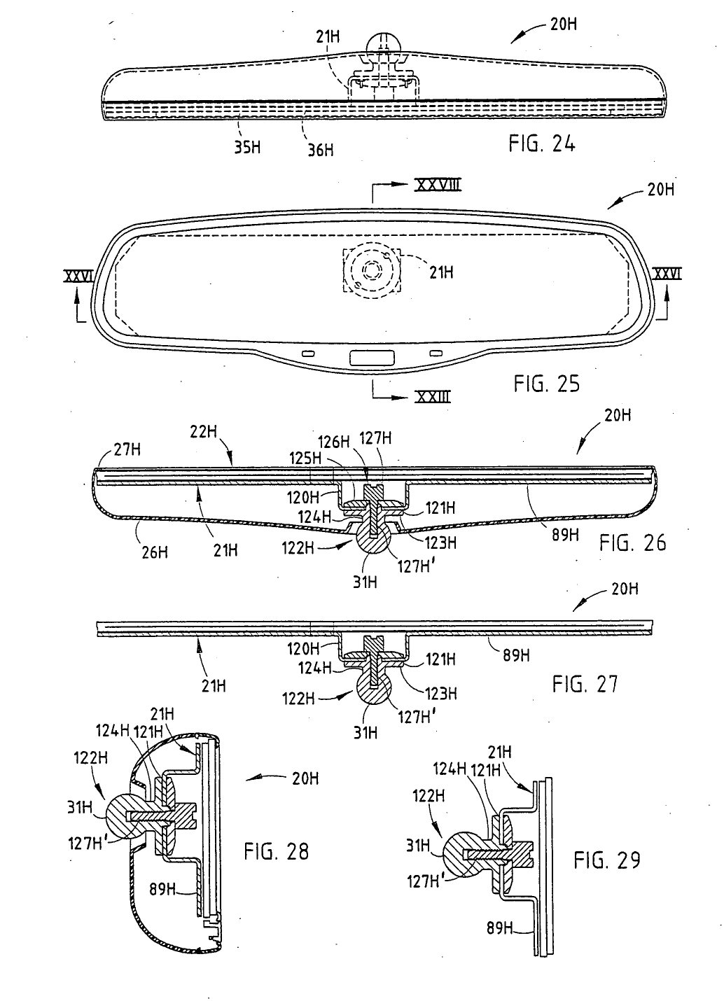

The mirror 20H (FIGS. 24-29) include a plate frame 21H (FIG. 26), an electrochromic mirror subassembly 22H supported on the plate frame 21H, and a bezel 27H and back cover 26H. The plate frame 21H includes a cup-shaped mount 120H including a flat wall 121H formed from the material of plate portion 89H of plate frame 21H. A connection member 122H includes a flat base 123H that engage wall 121H, a stem 124H, and a ball section 31H. A washer 125H is positioned under the flat section 121H with the base 123H opposite the washer 125H. A screw 126H includes a head 127H positioned within the cup-shaped member 121H, and includes a threaded shaft 127H′ that extends through a hole in the washer 125H, through a hole in the flat wall 121H, and threadably into a hole that extends up through stem 124H into ball section 31H. The screw 126H includes a length that extends substantially into the ball section 31H. However, it is contemplated that the shaft length of the screw 126H can be significantly shorter. Further, the hole can be extended through the ball section 31H and connected to a passageway formed laterally out of a side of the stem 124H. Thus, a wire passageway can be formed to communicate wires centrally through the ball section 31H into the stem 124H and out a side of the stem under the cover 26H into a backside of the plate frame 21H for connection to circuitry within the mirror.

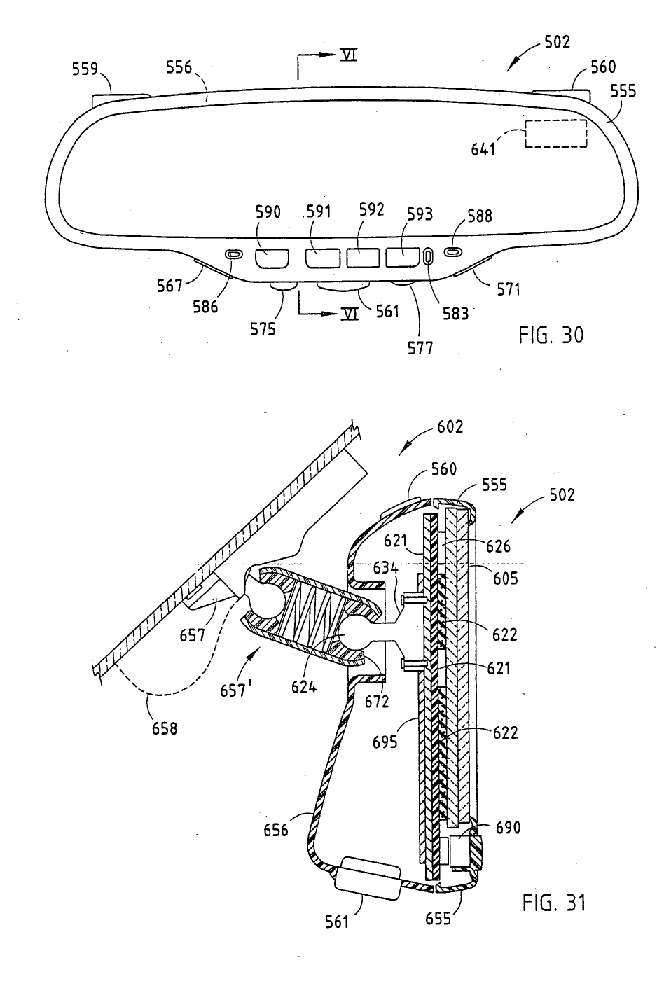

It is contemplated that the present inventive concepts can be used in combination with mirrors (interior and/or exterior) having many different options to create synergistic and non-obvious combinations that provide surprising and unexpected benefits not previously possible. For example, turning now to FIG. 30, an interior mirror assembly 502 includes a bezel 555 and a case 556 mounted on an internal frame 621 (FIG. 31). The bezel and the case combine to define a mirror housing for incorporation of features in addition to a reflective element and information display. Commonly assigned U.S. Pat. Nos. 6,102,546; D 410,607; 6,407,468; 6,420,800; and U.S. Pat. No. 6,471,362, the disclosures of which are incorporated in their entireties herein by reference, describe various bezels, cases, and associated button construction for use with the present invention.

As depicted in FIG. 30, the mirror assembly may include top and/or bottom microphones 559. Examples of microphones for use with the present invention are described in commonly assigned U.S. Pat. No. 5,988,935 and U.S. Patent Publication No. 2002/0110256, the disclosures of which are incorporated in their entireties herein by reference. As depicted in FIGS. 30-32, the microphone 561 or microphones 560 may be mounted on the top of the mirror assembly, on the bottom of the mirror assembly, on the backside of the mirror case, or anywhere within the mirror case or bezel. Preferably, two microphones are incorporated, one near each end, into the mirror assembly on the backside of the mirror case within recessed portion as shown in FIGS. 30-32. These systems may be integrated, at least in part, in a common control with information displays and/or may share components with the information displays. In addition, the status of these systems and/or the devices controlled thereby may be displayed on the associated information displays.

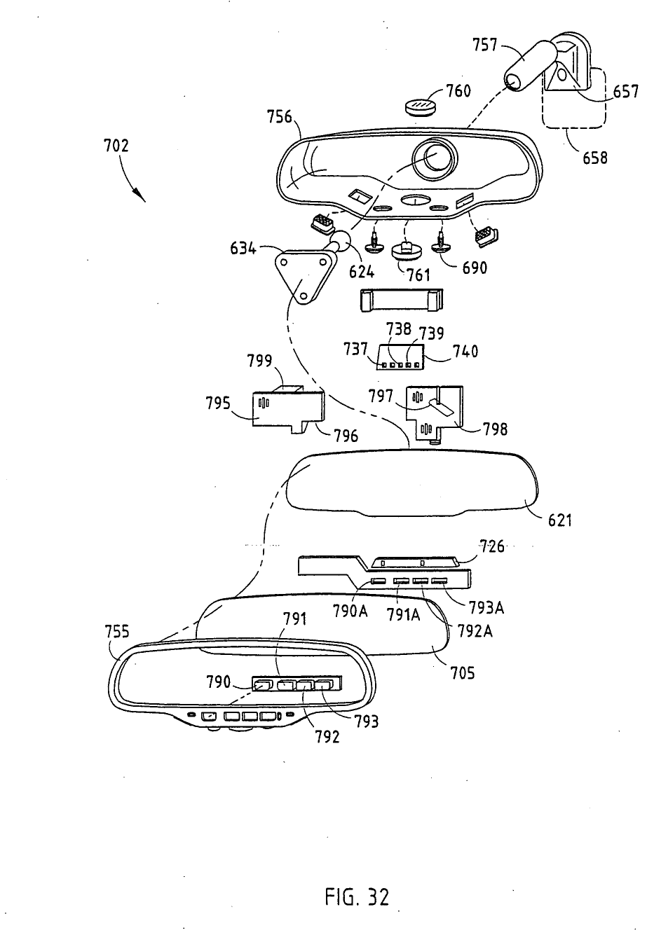

With further reference to FIG. 30, mirror assembly 502 includes first and second illumination assemblies 567, 571. Various illumination assemblies and illuminators for use with the present invention are described in commonly assigned U.S. Pat. Nos. 5,803,579 and 6,335,548, as well as commonly assigned U.S. Pat. No. 6,521,916, the disclosures of which are incorporated in their entireties herein by reference. As further depicted in FIG. 32, each illumination assembly preferably comprises a reflector, a lens, and an illuminator (not shown). Most preferably there are two illumination assemblies with one generally positioned to illuminate a driver seat area. There may be only one or may be additional illuminator assemblies such as one to illuminate a center console area, overhead console area or an area between the front seats.

With further reference to FIG. 30, mirror assembly 502 includes first and second switches 575, 577. Suitable switches for use with the present invention are described in detail in commonly assigned U.S. Pat. Nos. 6,407,468 and 6,420,800, as well as commonly assigned U.S. Pat. Nos. 6,471,362 and 6,614,579, the disclosures of which are incorporated in their entireties herein by reference. These switches may be incorporated to control the illumination assemblies, the displays, the mirror reflectivity, a voice-activated system, a compass system, a telephone system, a highway toll booth interface, a telemetry system, a headlight controller, a rain sensor, etc. Any other display or system described herein or within the references incorporated by reference may be incorporated in any location within the associated vehicle and may be controlled using the switches.

With further reference to FIG. 30, mirror assembly 502 includes indicators 583. Various indicators for use with the present invention are described in commonly assigned U.S. Pat. Nos. 5,803,579 and 6,335,548, as well as commonly assigned U.S. Pat. No. 6,521,916, the disclosures of which are incorporated in their entireties herein by reference. These indicators may indicate the status of the displays, the mirror reflectivity, a voice-activated system, a compass system, a telephone system, a highway toll booth interface, a telemetry system, a headlight controller, a rain sensor, etc. Any other display or system described herein or within the references incorporated by reference may be incorporated in any location within the associated vehicle and may have a status depicted by the indicators.

With further reference to FIG. 30, mirror assembly 502 includes first and second light sensors 586, 588 (glare and ambient sensors in FIG. 7). Preferred light sensors for use within the present invention are described in detail in commonly assigned U.S. Pat. Nos. 5,923,027 and 6,313,457, the disclosures of which are incorporated in their entireties herein by reference. The glare sensor and/or ambient sensor automatically control the reflectivity of a self-dimming reflective element as well as the intensity of information displays and/or backlighting. The glare sensor is used to sense headlights of trailing vehicles and the ambient sensor is used to detect the ambient lighting conditions that the system is operating within. In another embodiment, a sky sensor may be incorporated positioned to detect light levels generally above and in front of an associated vehicle, the sky sensor may be used to automatically control the reflectivity of a self-dimming element, the exterior lights of a controlled vehicle and/or the intensity of information displays.

With further reference to FIG. 30, mirror assembly 502 includes first, second, third, and fourth operator interfaces 590, 591, 592, 593 located in mirror bezel 555. Each operator interface is shown to comprise a backlit information display “A”, “AB”, “A1 ”, and “12”. It should be understood that these operator interfaces can be incorporated anywhere in the associated vehicle, for example, in the mirror case, accessory module, instrument panel, overhead console, dashboard, seats, center console, etc. Suitable switch construction is described in detail in commonly assigned U.S. Pat. Nos. 6,407,468 and 6,420,800, as well as commonly assigned U.S. Pat. Nos. 6,471,362 and 6,614,579, the disclosures of which are incorporated in their entireties herein by reference. These operator interfaces may control the illumination assemblies, the displays, the mirror reflectivity, a voice-activated system, a compass system, a telephone system, a highway toll booth interface, a telemetry system, a headlight controller, a rain sensor, etc. Any other display or system described herein or within the references incorporated by reference may be incorporated in any location within the associated vehicle and may be controlled using an operator interface or interfaces. For example, a user may program a display or displays to depict predetermined information or may program a display or displays to scroll through a series of information, or may enter set points associated with certain operating equipment with associated sensor inputs to display certain information upon the occurrence of a given event. In one embodiment, for example, a given display may be in a non-illuminated state until the engine temperature is above a threshold, the display then automatically is set to display the engine temperature. Another example is that proximity sensors located on the rear of a vehicle may be connected to a controller and combined with a display in a rearview mirror to indicate to a driver the distance to an object; the display may be configured as a bar that has a length proportional to the given distance.

Although specific locations and numbers of these additional features are depicted in FIG. 30, it should be understood that fewer or more individual devices may be incorporated in any location within the associated vehicle and as described within the references incorporated herein.

Turning now to FIG. 31, there is shown a section view of a mirror assembly 602, with a reflective electrochromic subassembly 605 adhered to an internal plate frame 621 with double-sided adhesive foam tape 622. Attachment component 634 is screwed to (or integrally formed from) plate frame 621 and defines a crown 672 that engages a ball section 624. The depicted section of FIG. 31 is taken along cut line 6-6 of FIG. 30, shows a preferred positional relationship of third and fourth information displays 626, 641 with respect to reflective EC element 605 along with third information display backlighting 627 within a housing defined by case 656 and bezel 655. Mirror assembly 602 is also shown to comprise a microphone 659; first operator interface 690; along with circuit board 695; mirror mount 657 and accessory module 658. The mirror mount 657 and/or an accessory module 658 may comprise compass sensors, a camera, a headlight control, an additional microprocessor, a rain sensor, additional information displays, additional operator interfaces, etc.

Turning now to FIG. 32, there is shown an exploded view of a mirror assembly 702. FIG. 32 provides additional detail with regard to one preferred positional relationship of individual components, as well as providing additional structural detail of a mirror assembly. Mirror assembly 702 comprises a reflective element 705 within a bezel 755 and a mirror case 756. A mirror mount 757 is included for mounting the mirror assembly within a vehicle. It is noted that a person skilled in the art of vehicle mirror design can re-design the bezel 755, mirror case 756, and tube mount 757 to be replaced with other bezel designs and/or mirror housing designs previously described in this application. It should be understood that a host of accessories may be incorporated into the mount 757 and/or onto the plate frame 621 in addition to a power pack adjuster, such as a rain sensor, a camera, a headlight control, an additional microprocessor, additional information displays, compass sensors, etc. These systems may be integrated, at least in part, in a common control with information displays and/or may share components with the information displays. In addition, the status of these systems and/or the devices controlled thereby may be displayed on the associated information displays.

Mirror assembly 702 is shown in FIG. 32 to further comprise third information display 726 with third information display backlighting 737, 738, 739; first and second microphones 760, 761; and including other known options such as a first reflector with a first lens; a second reflector with a second lens; a glare sensor; an ambient light sensor; first, second, third, and fourth operator interfaces 790, 791, 792, 793, with first, second, third, and fourth operator interface backlighting 790a, 791a, 792a, 793a; a circuit board 795 having a compass sensor module 799; and a daughter board 798 with an input/output bus interface 797.

Preferably, the illumination assemblies with associated light source are constructed in accordance with the teachings of commonly assigned U.S. Pat. Nos. 5,803,579 and 6,335,548, as well as U.S. Pat. No. 6,521,916, the disclosures of which are incorporated in their entireties herein by reference.

Preferably, the glare light sensor and the ambient light sensor are active light sensors as described in commonly assigned U.S. Pat. Nos. 6,359,274 and 6,402,328, the disclosures of which are incorporated in their entireties herein by reference. The electrical output signal from either, or both, of the sensors may be used as inputs to a controller 796 on the circuit board 740 or 795 to control the reflectivity of reflective element 705 and/or the intensity of third information display backlighting. The details of various control circuits for use herewith are described in commonly assigned U.S. Pat. Nos. 5,956,012; 6,084,700; 6,222,177; 6,224,716; 6,247,819; 6,249,369; 6,392,783; and 6,402,328, the disclosures of which are incorporated in their entireties herein by reference. These systems may be integrated, at least in part, in a common control with information displays and/or may share components with the information displays. In addition, the status of these systems and/or the devices controlled thereby may be displayed on the associated information displays.

Although the compass sensor module 799 is shown to be mounted circuit board 795 in FIG. 32, it should be understood that the sensor module may be located within mount 757, an accessory module 758 positioned proximate mirror assembly 702 or at any location within an associated vehicle such as under a dashboard, in an overhead console, a center console, a trunk, an engine compartment, etc. Commonly assigned U.S. Pat. No. 6,023,229 and 6,140,933, as well as commonly assigned U.S. Patent Publication No. 2003/0167121 and U.S. Patent Application No. 60/360,723, the disclosures of which are incorporated in their entireties herein by reference, described in detail various compass systems for use with the present invention. These systems may be integrated, at least in part, in a common control with information displays and/or may share components with the information displays. In addition, the status of these systems and/or the devices controlled thereby may be displayed on the associated information displays.

Daughter board 798 is in operational communication with circuit board 795. Circuit board 795 may comprise a controller 796, such as a microprocessor, and daughter board 798 may comprise an information display (not shown in FIG. 7). The microprocessor may, for example, receive signal(s) from the compass sensor module 799 and process the signal(s) and transmit signal(s) to the daughter board to control a display to indicate the corresponding vehicle heading. As described herein and within the references incorporated by reference herein, the controller may receive signal(s) from light sensor(s), rains sensor(s) (not shown), automatic vehicle exterior light controller(s) (not shown), microphone(s), global positioning systems (not shown), telecommunication systems (not shown), operator interface(s), and a host of other devices, and control the information display(s) to provide appropriate visual indications.

Controller 796 (or controllers) may, at least in part, control the mirror reflectivity, exterior lights, rain sensor, compass, information displays, windshield wipers, heater, defroster, defogger, air conditioning, telemetry systems, voice recognition systems such as digital signal processor-based voice-actuation systems, and vehicle speed. The controller 796 (or controllers) may receive signals from switches and/or sensors associated with any of the devices described herein and in the references incorporated by reference herein to automatically manipulate any other device described herein or described in the references included by reference. The controller 796 may be, at least in part, located outside the mirror assembly or may comprise a second controller elsewhere in the vehicle or additional controllers throughout the vehicle. The individual processors may be configured to communicate serially, in parallel, via Bluetooth protocol, wireless communication, over the vehicle bus, over a CAN bus or any other suitable communication.

Exterior light control systems as described in commonly assigned U.S. Pat. Nos. 5,990,469; 6,008,486; 6,130,421; 6,130,448; 6,255,639; 6,049,171; 5,837,994; 6,403,942; 6,281,632; 6,291,812; 6,469,739; 6,399,049; 6,465,963; 6,621,616; 6,587,573; 6,653,614; 6,429,594; 6,379,013; U.S. Patent Application Nos. 60/404,879 and 10/208,142; and U.S. Patent Publication No. 2003/0107323, the disclosures of which are incorporated in their entireties herein by reference, may be incorporated in accordance with the present invention. These systems may be integrated, at least in part, in a common control with information displays and/or may share components with the information displays. In addition, the status of these systems and/or the devices controlled thereby may be displayed on the associated information displays.

Moisture sensors and windshield fog detector systems are described in commonly assigned U.S. Pat. Nos. 5,923,027 and 6,313,457, the disclosures of which are incorporated in their entireties herein by reference. These systems may be integrated, at least in part, in a common control with information displays and/or may share components with the information displays. In addition, the status of these systems and/or the devices controlled thereby may be displayed on the associated information displays.

Commonly assigned U.S. Pat. No. 6,262,831, the disclosure of which is incorporated herein by reference in its entirety, describes power supplies for use with the present invention. These systems may be integrated, at least in part, in a common control with information displays and/or may share components with the information displays. In addition, the status of these systems and/or the devices controlled thereby may be displayed on the associated information displays.

It is contemplated that the present invention would be useful in inside or outside rearview mirrors having optical electrochromic mirror elements, convex mirror elements, aspheric mirror elements, planar mirror elements, non-planar mirror elements, hydrophilic mirror elements, hydrophobic mirror elements, and mirror elements having third surface and fourth surface reflectors. It is further contemplated that the present invention will be useful on mirrors that are transflective, or that have a third or fourth surface mirror element with patterns of lines thereon to optimize the effect of visible light (sometimes called “jail bars”). Further, the present invention is useful with mirrors having first surface or fourth surface heaters, anti-scratch layers, and circuit boards including flexible circuit boards, and circuit board and heater combinations, such as heaters having embedded or integrated non-heater functions such as signal ellipses and signal diffusants, locating holes or windows for light pass-through. The present invention is also useful with potted or snap-attached or elastomeric bezels, and useful with carriers having an ultra-flat front surface. Also, additional options can be integrated into the mirrors including signal lighting, key lights, radar distance detectors, puddle lights, information displays, light sensors and indicator and warning lighting, retainers with living hinges, and integrated housings for receiving and supporting said components. Still further, it is conceived that the present mirror can include a manually folding or power folding mirrors, extendable mirrors, and mirrors with a wide field of view, and with information on the mirror such as “object in mirror is closer than may appear” or other indicia, such as “heated” or “auto-dim”. Still further, the present invention is useful with a blue glass mirror or “blue chemical” darkening mirror. Still further, efficiencies can be had by incorporating the present concepts with mirrors having an electrochromic mirror subassembly with front and rear glass mirror elements with edges having a “zero offset” (i.e. less than about 1-mm difference between perfect alignment edges of the mirror elements), an edge seal, including clear reflective or opaque edge seals, and/or second surface chrome or a chrome bezel.

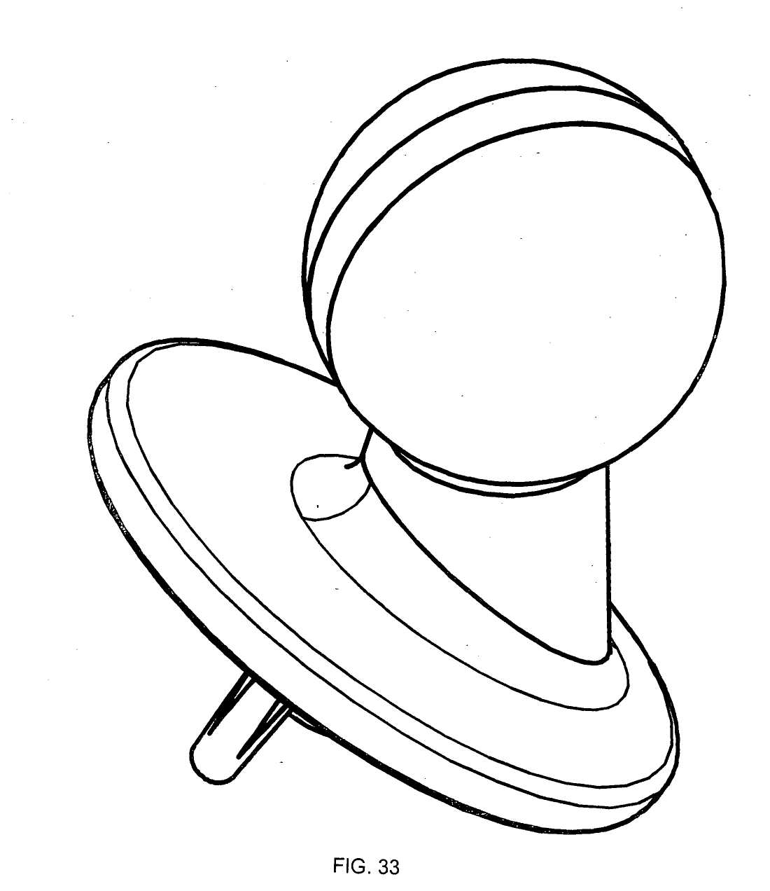

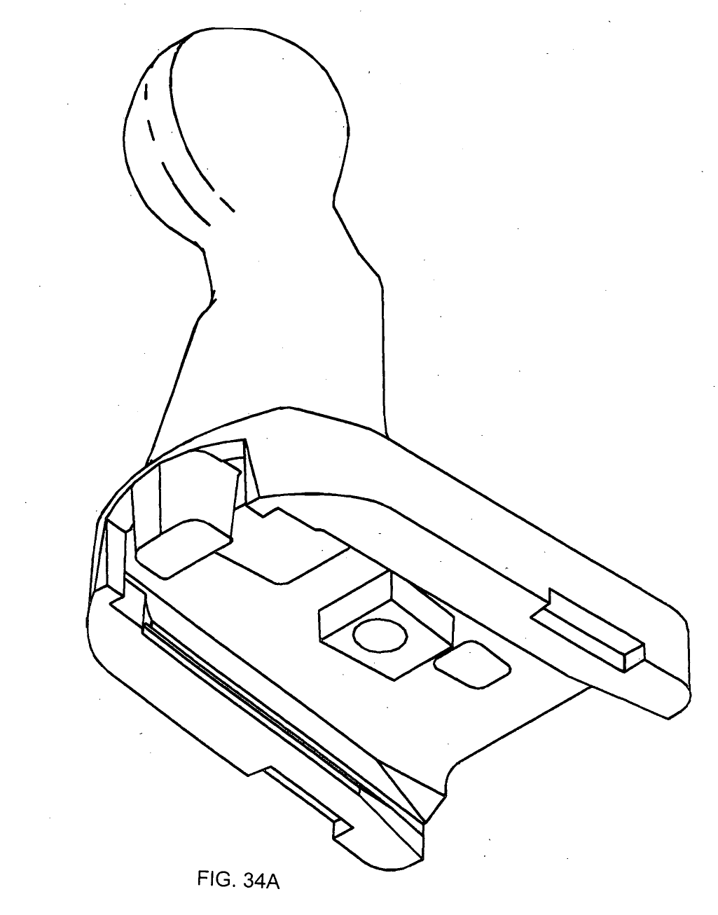

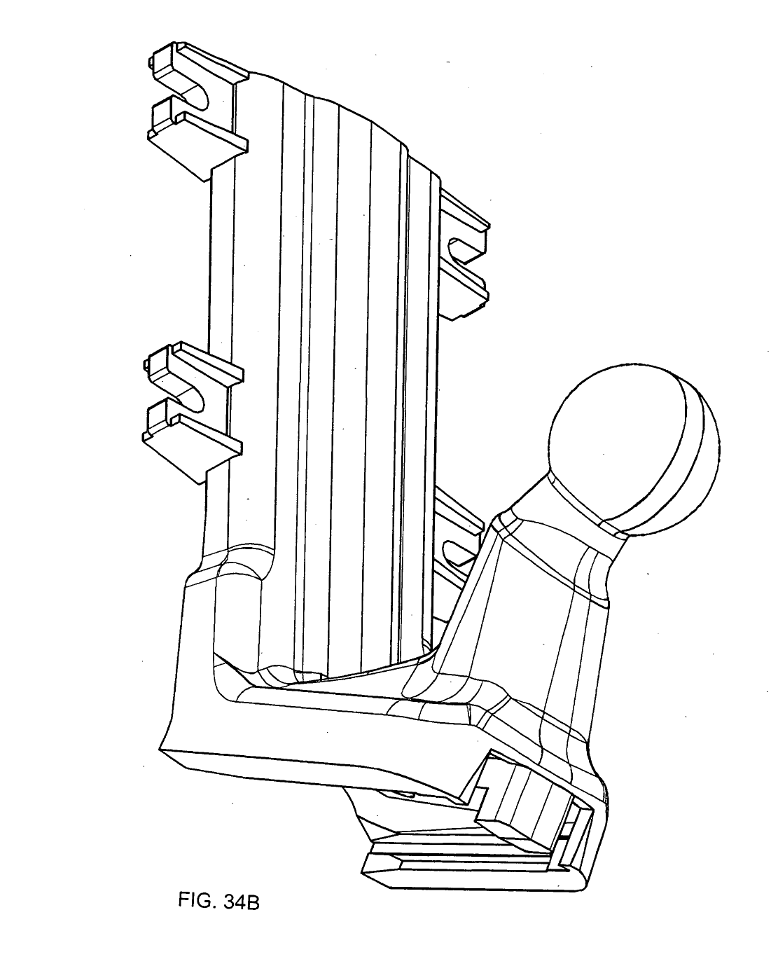

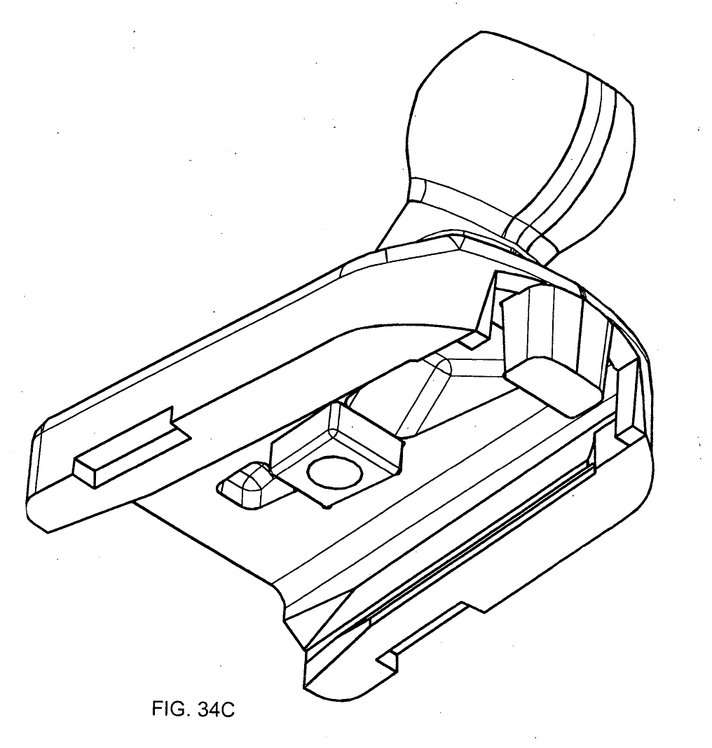

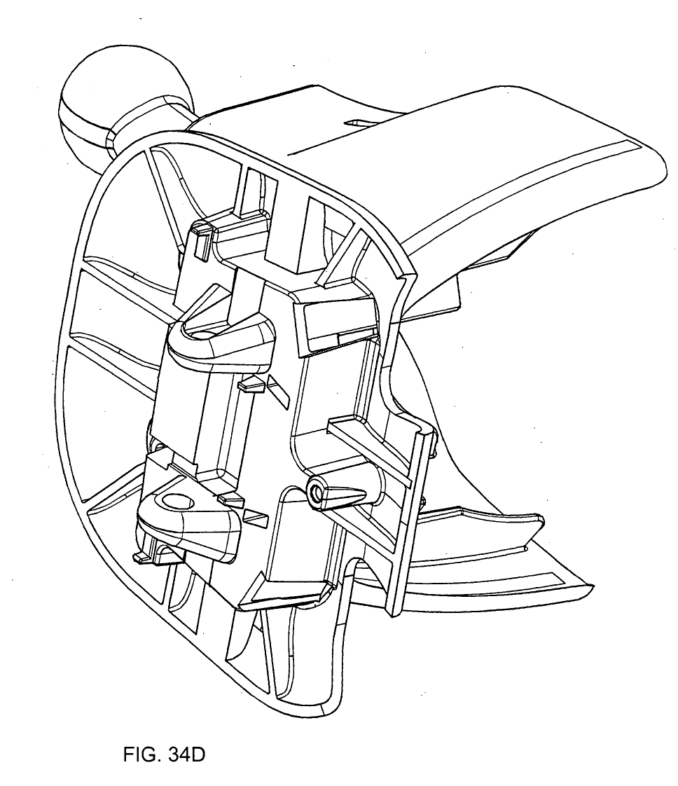

As set forth above, the illustrated apparatus 18 can include a plate frame 21 or an integral plate frame 21A, stem 70A and ball section 31A formed from a material comprising a magnesium alloy. Furthermore, other components of the apparatus 18 can be made from a material comprising a magnesium alloy. The components of the apparatus 18 that can be made from the material comprising a magnesium alloy at least include all components previously made from zinc or plastic. Accordingly, the apparatus 18 could include the following made from the material comprising a magnesium alloy: the plate frame 21, the integral plate frame 21A, stem 70A and ball section 31A, the cover 26, the bezel 27, the mount 33 having the ball section 31, a ball section interconnected to but separate from the plate frame 21 (FIG. 33), and others. Various mounts 33 having the ball section 31 integral therewith and made from the material comprising a magnesium alloy are illustrated in FIGS. 34A-34D.

Preferably, the material comprising a magnesium alloy is a composition including magnesium that comprises greater than 50% of the total composition by weight, such as AZ91D, AM-50A or AM-60B (as set forth by ASTM standards). However, it is contemplated that other magnesium alloys could be used. Furthermore, the components made from the material comprising a magnesium alloy are preferably thixo-formed. Magnesium alloys can be used in a thixo-forming process by shearing the material comprising a magnesium alloy, when in a semi-solid form, with a rotating screw and then injecting the material comprising a magnesium alloy into a mold having the desired shaped of the component formed from the material comprising a magnesium alloy. As used herein, the term “thixo-forming” includes thixo-molding or thixo-casting. The thixo-forming can be performed using the method disclosed in U.S. Pat. No. 5,040,589 entitled METHOD AND APPARATUS FOR THE INJECTION MOLDING OF METAL ALLOYS, the entire contents of which are hereby incorporated herein by reference.

In the illustrated example, components of the apparatus 18 made from a material comprising a magnesium alloy have several advantageous properties. For example, materials comprising a magnesium alloy have improved weight characteristics, stiffness, dampening characteristics and dimensional stability compared to zinc alloys, plastics and other materials previously used to make interior rearview mirror assembly components. Since the magnesium alloy provides improved weight, stiffness, dampening characteristics and dimensional stability, the components can be thinner than the components as made in the prior art. Therefore, the wall of the cover or any of the walls of the mounts 31 made from a material comprising a magnesium alloy can have a thickness of less than about 0.75 mm, whereas the prior art wall had a thickness of about 1.0-1.5 mm at a minimum. Moreover, since the component made from a material comprising a magnesium alloy includes improved weight, stiffness, dampening characteristics and dimensional stability, as because the material does not creep, the ball with the passageway therethrough as disclosed in FIGS. 7 or 9 does not need any internal support. Furthermore, if the ball included a longitudinal split for laying wiring therein as disclosed in U.S. Pat. No. 6,467,919 entitled MIRROR WITH SPLIT BALL MOUNT AND HOLD-OPEN DEVICE, the entire contents of which are hereby incorporated herein by reference, the ball with the longitudinal split would not need the hold-open device when the ball is made from a material comprising a magnesium alloy. Finally, the components made from a material comprising a magnesium alloy provide electromagnetic shielding for shielding the electrical and magnetic components within the interior rearview mirror assembly.

Table 1 illustrates the mechanical and physical properties of materials comprising a magnesium alloy along with the prior art zinc alloys and a thermoplastic previously used to make interior rearview mirror assembly components.

TABLE 1
MATERIAL PROPERTIES

| | | | | | | CYCOLOY ® |
|---|---|---|---|---|---|---|
| | | | | ZAMAK 3 | A 380 | LG9000 as |
| | | AM- | AM- | (Zinc | (Zinc | sold by GE |
| | AZ91D | 60B | 50A | alloy) | alloy) | (thermoplastic) |
| Tensile Strength, | 35 (241) | 36.5 | 34.5 | 41 (283) | 47 (320) | 7.9 |
| ksi (MPa) | | (252) | (238) | | | |
| Tensile Yield, ksi | 22.5 | 18.2 | 17.0 | 32 (221) | 23 (160) | |
| (MPa) | (155) | (125) | (117) | | | |
| Comp. Strength, | 58 (400) | | | | | |
| ksi (MPa) | | | | | | |
| Comp. Yield, ksi (MPa) | 23 (165) | | | 60 (414) | | |
| Elongation, % in 2 | 3 | | | 10 | 3.5 | |
| inches | | | | | | |
| Young's Modulus, | 6.5 (45) | 6.5 | 6.5 | 12.4 | 10.3 | |
| Msi (GPa) | | (45) | (45) | (85.5) | (71.0) | |
| Poisson's Ratio | 0.35 | 0.35 | 0.35 | 0.39 | 0.37 | |
| Shear Strength, | 20 (140) | | | 31 (214) | 27 | |
| ksi (MPa) | | | | | (1900) | |
| Fatigue Strength, | 10 (70) | 10 | 10 | 6.9 (47.6) | 20 (138) | |
| ksi (MPa) | | (70) | (70) | | | |
| Impact Strength, | 1.6 (2.2) | 4.5 | 7.0 | 43 (58) | 3 (4) | |
| ksi (MPa) | | (6.1) | (9.5) | | | |
| Creep Strength, | 2.8 (20) | | | | | |
| ksi (MPa) | | | | | | |
| Hardness, Brinell | 63 | | | 82 | 80 | |
| Density, lb/in³ | 0.066 | 0.065 | 0.064 | 0.24 (6.6) | 0.097 | |
| (g/cm³) | (1.81) | (1.79) | (1.78) | | (2.74) | |
| Therm Cond., | 41.8 (72) | 36 | 36 | 65.3 | 55.6 | |
| BTU/ft · hr · ° F. | | (61) | (61) | (113.0) | (96.2) | |
| (W/m · K) | | | | | | |
| Therm. Exp., | 13.8 | 14.2 | 14.4 | 15.2 | 12.2 | |
| μin/in° F. (μm/m · K) | (25.0) | (25.6) | (26.0) | (27.4) | (21.8) | |
| Specific Heat, | 0.25 | 0.25 | 0.25 | 0.10 | 0.23 | |
| Btu/lb · ° F. (kJ/Kg · K) | (1.05) | (1.05) | (1.05) | (0.42) | (0.90) | |
| Latent Heat of | 160 | 160 | 160 | | | |
| Fusion, Btu/lb (kJ/kg) | (373) | (373) | (373) | | | |
| Elec. Resistivity, | 35.8 | 31.8 | 31.8 | 27 (69) | 27 (69) | |
| μW · in (μW · cm) | (14.1) | (12.5) | (12.5) | | | |
| Solidus Temp., ° F. | 875 | 1005 | 1010 | 718 (381) | 1000 | |
| (° C.) | (470) | (540) | (543) | | (540) | |
| Liquidus Temp., | 1105 | 1140 | 1150 | 728 (387) | 1100 | |
| ° F. (° C.) | (595) | (615) | (620) | | (595) | |
| Casting Temp., ° F. | 1160-1290 | | | | | |
| Casting Temp., | 625-700 | | | | | |
| ° C. | | | | | | |

Preferably, the dimensional stability of the component made from the material comprising a magnesium alloy has a dimensional stability similar to plastic that can be used as a cosmetic surface and can accept paint thereon, thereby providing a textured surface acceptable for end use by a consumer. Furthermore, the light weight of the components made from the material comprising a magnesium alloy provides the interior rearview mirror assembly with improved dampening characteristics.

It is to be understood that variations and modifications can be made on the aforementioned structure without departing from the concepts of the present invention, and further it is to be understood that such concepts are intended to be covered by the following claims unless these claims by their language expressly state otherwise.

1. A method of making an interior rearview mirror assembly comprising:
providing interior rearview mirror components, the components comprising a plate frame, a cover, a mount and a pivot ball;
providing a mirror;
assembling the interior rearview mirror components and the mirror to form the interior rearview mirror assembly;
wherein providing the interior rearview mirror components includes thixo-forming at least one of the components from a material comprising magnesium.

2. The method of making an interior rearview mirror assembly of claim 1, wherein:
the at least one of the components includes a wall having a thickness of less than about 0.75 mm.

3. The method of making an interior rearview mirror assembly of claim 2, wherein:
the at least one of the components including the wall comprises the cover.

4. The method of making an interior rearview mirror assembly of claim 2, wherein:
the at least one of the components including the wall comprises the mount.

5. The method of making an interior rearview mirror assembly of claim 1, wherein:
the at least one of the components comprises the plate frame.

6. The method of making an interior rearview mirror assembly of claim 1, wherein:
the at least one of the components comprises the pivot ball.

7. The method of making an interior rearview mirror assembly of claim 1, wherein:
the at least one of the components comprises the cover.

8. The method of making an interior rearview mirror assembly of claim 1, wherein:
the cover comprises a shell without support ribs.

9. The method of making an interior rearview mirror assembly of claim 1, wherein:
providing the interior rearview mirror components includes providing an integral pivot ball and plate frame.

10. The method of making an interior rearview mirror assembly of claim 9, wherein:
the at least one of the components comprises the integral pivot ball and plate frame.

11. The method of making an interior rearview mirror assembly of claim 1, wherein:
providing the interior rearview mirror components includes providing an integral pivot ball, stem and plate frame.

12. The method of making an interior rearview mirror assembly of claim 11, wherein:
the at least one of the components comprises the integral pivot ball, stem and plate frame.

13. The method of making an interior rearview mirror assembly of claim 1, wherein:
the interior rearview mirror components further include a bezel.

14. The method of making an interior rearview mirror assembly of claim 13, wherein:
the at least one of the components includes the bezel.

15. The method of making an interior rearview mirror assembly of claim 1, wherein:
the pivot ball and the mount are integral.

16. The method of making an interior rearview mirror assembly of claim 15, wherein:
the at least one of the components comprises the integral pivot ball and mount.

17. The method of making an interior rearview mirror assembly of claim 1, further including:
providing a circuit board; and
placing the mirror and the circuit board in the cover.

18. The method of making an interior rearview mirror assembly of claim 1, further including:
spacing the pivot ball and the plate frame.

19. The method of making an interior rearview mirror assembly of claim 1, further including:
providing a mount ball integral with the mount; and
connecting the pivot ball to the plate frame, inserting the pivot ball into a first end of the sleeve and inserting the mount ball into a second end of the sleeve.

20. The method of making an interior rearview mirror assembly of claim 19, further including:
forming the mount ball from a material comprising magnesium.

21. An interior rearview mirror assembly made from the method of claim 1.

22. The interior rearview mirror assembly of claim 21, wherein:
at least one of the components includes a wall having a thickness of less than about 0.75 mm.

23. The interior rearview mirror assembly of claim 22, wherein:
the at least one of the components including the wall comprises the cover.

24. The interior rearview mirror assembly of claim 22, wherein:
the at least one of the components including the wall comprises the mount.

25. The interior rearview mirror assembly of claim 21, wherein:
the at least one of the components comprises the plate frame.

26. The interior rearview mirror assembly of claim 21, wherein:
the at least one of the components comprises the pivot ball.

27. The interior rearview mirror assembly of claim 21, wherein:
the at least one of the components comprises the cover.

28. The interior rearview mirror assembly of claim 21, wherein:
the cover comprises a shell without support ribs.

29. The interior rearview mirror assembly of claim 21, wherein:
the pivot ball and the plate frame are integral.

30. The interior rearview mirror assembly of claim 29, wherein:
the at least one of the components comprises the integral pivot ball and plate frame.

31. The interior rearview mirror assembly of claim 21, wherein:
the pivot ball and the plate frame are integral with a stem.

32. The interior rearview mirror assembly of claim 31, wherein:
the at least one of the components comprises the integral pivot ball, stem and plate frame.

33. The interior rearview mirror assembly of claim 21, wherein:
the interior rearview mirror components further include a bezel.

34. The interior rearview mirror assembly of claim 33, wherein:
the at least one of the components includes the bezel.

35. The interior rearview mirror assembly of claim 21, wherein:
the pivot ball and the mount are integral.

36. The interior rearview mirror assembly of claim 35, wherein:
the at least one of the components comprises the integral pivot ball and mount.

37. The interior rearview mirror assembly of claim 21, further including:
providing a circuit board; and
placing the mirror and the circuit board in the cover.

38. The interior rearview mirror assembly of claim 21, further including:
spacing the pivot ball and the plate frame.

39. The interior rearview mirror assembly of claim 21, further including:
providing a mount ball integral with the mount; and
connecting the pivot ball to the plate frame, inserting the pivot ball into a first end of the sleeve and inserting the mount ball into a second end of the sleeve.

40. The interior rearview mirror assembly of claim 39, further including:
forming the mount ball from a material comprising magnesium.

41. A method of making an interior rearview mirror assembly comprising:
providing interior rearview mirror components, the components comprising a plate frame and a cover;
providing a mirror; and
assembling the interior rearview mirror components and the mirror to form the interior rearview mirror assembly;
wherein providing the interior rearview mirror components includes forming at least one of the components from a material comprising magnesium.

42. The method of making an interior rearview mirror assembly of claim 41, wherein:
the at least one of the components is the plate frame.

43. The method of making an interior rearview mirror assembly of claim 41, further including:
a pivot ball interconnected to the plate frame.

44. The method of making an interior rearview mirror assembly of claim 43, wherein:
the pivot ball is formed from a material comprising magnesium.

45. The method of making an interior rearview mirror assembly of claim 41, wherein:
the at least one of the components is the cover.

46. The method of making an interior rearview mirror assembly of claim 41, wherein:
the cover comprises a shell without support ribs.

47. The method of making an interior rearview mirror assembly of claim 41, wherein:
providing the interior rearview mirror components includes providing an integral pivot ball and plate frame.

48. The method of making an interior rearview mirror assembly of claim 47, wherein:
the at least one of the components is the integral pivot ball and plate frame.

49. The method of making an interior rearview mirror assembly of claim 41, wherein:
providing the interior rearview mirror components includes providing an integral pivot ball, stem and plate frame.

50. The method of making an interior rearview mirror assembly of claim 49, wherein:
the at least one of the components is the integral pivot ball, stem and plate frame.

51. The method of making an interior rearview mirror assembly of claim 41, wherein:
forming at least one of the components from a material comprising magnesium comprises thixomolding the at least one of the components.

52. The method of making an interior rearview mirror assembly of claim 41, wherein:
the interior rearview mirror components further include a bezel.

53. The method of making an interior rearview mirror assembly of claim 52, wherein:
the at least one of the components is the bezel.

54. The method of making an interior rearview mirror assembly of claim 41, further including:
providing an integral pivot ball and mount; and
interconnecting the integral pivot ball and mount to the cover.

55. The method of making an interior rearview mirror assembly of claim 54, wherein:
the integral pivot ball and mount is formed from a material comprising magnesium.

56. The method of making an interior rearview mirror assembly of claim 41, further including:
providing a circuit board; and
placing the mirror and the circuit board in the cover.

57. The method of making an interior rearview mirror assembly of claim 41, further including:
providing a pivot ball; and
spacing the pivot ball and the plate frame.

58. The method of making an interior rearview mirror assembly of claim 41, further including:
providing a first pivot ball, a sleeve and a second pivot ball integral with a mount; and
connecting the pivot ball to the plate frame, inserting the pivot ball into a first end of the sleeve and inserting the second pivot ball into a second end of the sleeve.

59. The method of making an interior rearview mirror assembly of claim 58, wherein:
the second pivot ball and the mount are integral.

60. The method of making an interior rearview mirror assembly of claim 41, further including:
providing a pivot ball; and
forming the pivot ball from a material comprising magnesium.

61. The method of making an interior rearview mirror assembly of claim 41, wherein:
the at least one of the components includes a wall having a thickness of less than about 0.75 mm.

62. The method of making an interior rearview mirror assembly of claim 61, wherein:
the at least one of the components including the wall comprises the cover.

63. The method of making an interior rearview mirror assembly of claim 61, wherein:
the at least one of the components including the wall comprises the mount.

64. An interior rearview mirror assembly comprising:
a plate frame made of a material comprising magnesium;
an electrochromic mirror adjacent a front of the plate frame;
a circuit board adjacent a rear of the base frame;
a pivot ball connected to the plate frame for pivoting the electrochromic mirror;
a mount connected to the pivot ball and configured to be connected to a windshield of a vehicle.

65. The interior rearview mirror assembly of claim 64, wherein:
the plate frame and the pivot ball are integrally formed and made from the material comprising magnesium.

66. The interior rearview mirror assembly of claim 64, wherein:
the pivot ball includes a passageway therethrough.

67. The interior rearview mirror assembly of claim 64, wherein:
the mount and the pivot ball are integrally formed.

68. The interior rearview mirror assembly of claim 67, wherein:
the mount and the pivot ball are formed from the material comprising magnesium.

69. The interior rearview mirror assembly of claim 64, further including:
a cover surrounding a portion of the plate frame and the electrochromic mirror.

70. The interior rearview mirror assembly of claim 69, wherein:
the cover is made from a material comprising magnesium.

71. The interior rearview mirror assembly of claim 70, wherein:
the cover comprises a shell without support ribs.

72. The interior rearview mirror assembly of claim 69, further including:
a bezel connected to the cover.

73. The interior rearview mirror assembly of claim 72, wherein:
the bezel is made from a material comprising magnesium.

74. An interior rearview mirror assembly comprising:
a plate frame;
a stem extending from the plate frame; and
a pivot ball located on an end of the stem opposite the plate frame;
wherein the plate frame, the stem and the pivot ball are integrally formed from a material comprising magnesium.

75. The interior rearview mirror assembly of claim 74, wherein:
the stem and the pivot ball include a passageway therethrough.

76. The interior rearview mirror assembly of claim 75, wherein:
the stem includes a lateral opening connected to the passageway.

77. The interior rearview mirror assembly of claim 74, wherein:
the stem includes a channel for laying wires therein.

78. An interior rearview mirror assembly comprising:
a plate frame;
an electrochromic mirror adjacent a front of the plate frame;
a circuit board adjacent a rear of the base frame;
a cover surrounding the plate frame and the electrochromic mirror;
wherein at least one of the plate frame and the cover is formed from a material comprising magnesium.

79. The interior rearview mirror assembly of claim 78, further including:
a pivot ball connected to the plate frame for pivoting the electrochromic mirror; and
a mount connected to the pivot ball and configured to be connected to a windshield of a vehicle.

80. The interior rearview mirror assembly of claim 78, wherein:
the at least one of the plate frame and the cover includes the plate frame.

81. The interior rearview mirror assembly of claim 78, wherein:
the at least one of the plate frame and the cover includes the cover.

82. The interior rearview mirror assembly of claim 81, wherein:
the cover comprises a shell without support ribs.

83. The interior rearview mirror assembly of claim 78, further including:
a mount interconnected to the plate frame.

84. The interior rearview mirror assembly of claim 78, wherein:
the pivot ball and the plate frame are integrally formed.

85. The interior rearview mirror assembly of claim 84, wherein:
the integral pivot ball and plate frame is formed from a material comprising magnesium.

86. The interior rearview mirror assembly of claim 78, wherein:
the pivot ball, the plate frame and a stem are integrally formed.

87. The interior rearview mirror assembly of claim 86, wherein:
the integral pivot ball, stem and plate frame are formed from the material comprising magnesium.

88. The interior rearview mirror assembly of claim 78, further including:
a bezel connected to the cover.

89. The interior rearview mirror assembly of claim 88, wherein:
the bezel is formed from the material comprising magnesium.

90. The interior rearview mirror assembly of claim 78, further including:
an integral mount and pivot ball.

91. The interior rearview mirror assembly of claim 90, wherein:
the integral mount and pivot ball are formed from a material comprising magnesium.

92. The interior rearview mirror assembly of claim 78, further including:
further including a pivot ball;
wherein the pivot ball is spaced from the plate frame.

93. The interior rearview mirror assembly of claim 78, further including:
a first pivot ball interconnected to the plate frame and a second pivot ball;
a sleeve having a first end and a second end;
wherein the first pivot ball is inserted into the first end of the sleeve and the second ball is inserted into the second end of the sleeve.

94. The interior rearview mirror assembly of claim 93, wherein:
the second pivot ball and mount are integral and formed from a material comprising magnesium.

95. The interior rearview mirror assembly of claim 93, wherein:
the first pivot ball is formed from a material comprising magnesium.

96. An interior rearview mirror assembly comprising:
a plate frame;
an electrochromic mirror adjacent a front of the plate frame;
a circuit board adjacent a rear of the base frame;
a pivot ball connected to the plate frame for pivoting the electrochromic mirror; and
a mount connected to the pivot ball and configured to be connected to a windshield of a vehicle;
wherein at least one of the plate frame, the pivot ball and the mount are made of a material comprising magnesium.
